(19) United States
(12) Patent Application Publication
(10) Pub. No.: US 2024/0156127 A1
(43) Pub. Date: May 16, 2024

(54) MEAT ANALOGUE FOOD PRODUCT AND METHOD OF PRODUCING THEREOF

(71) Applicant: Solar Foods Oy, Lappeenranta (FI)

(72) Inventor: Anna HÄKÄMIES, Lappeenranta (FI)

(73) Assignee: Solar Foods Oy, Lappeenranta (FI)

(21) Appl. No.: 18/552,043

(22) PCT Filed: Apr. 7, 2022
(86) PCT No.: PCT/FI2022/050226

§ 371 Date: Sep. 22, 2023

(30) Foreign Application Priority Data
Apr. 27, 2021 (FI) 20215483

(51) Int. Cl. A23J 3/20; A23J 1/00; A23J 3/22

(52) U.S. Cl. CPC A23J 3/20; A23J 1/008; A23J 3/227

(57) ABSTRACT

Disclosed is a method of producing a meat analogue food product that includes mixing a microbial biomass protein slurry with a preparation with transglutaminase enzyme to obtain a protein mixture; incubating the protein mixture for a first period time with mixing at a temperature ranging from 28° C. up to 40° C.; adding at least one of selected from an aqueous MgCl₂ or an aqueous CaCl₂ to the protein mixture; incubating the protein mixture for a second period of time; incubating the protein mixture for a third period of time in a water bath at a temperature ranging from 40° C. up to 60° C.; heating the protein mixture at a temperature ranging from 60° C. up to 85° C.; and setting the protein mixture in a closed mold.

### TECHNICAL FIELD

The present disclosure relates generally to meat-analogues; and more specifically to methods of producing meat analogue food products, bearing tofu-like structure. Moreover, the present disclosure also relates to meat analogue food products obtained by the aforementioned methods.

### BACKGROUND

Protein, carbohydrates, fats, vitamins and minerals in proper proportions form important constituents of a balanced human diet. As a result, humans depend on a variety of food sources ranging from plants to animals. While animal-based food products provide most of the aforementioned nutrients, they are not suitable for consumption by everyone, such as consumers who identify as vegetarians, and in particular vegans, as well as patients suffering from high cholesterol, for example.

Currently, the high protein plant-based diet includes tofu, chia seeds, hemp seeds, quinoa, lentils and so on. Notably, 100 gm of tofu serves about 8 grams of protein, and thus, is the most favorite plant-based high-protein source. Moreover, tofu is very easy to make, from soy, and can be simply made at home. In this regard, enzyme transglutaminase is added to soy and the mixture is incubated to form a structure by binding proteins in soy. Conventional methods of preparing high-protein meat analogue food products, having tofu-like structure, include subjecting plant-based food sources to extrusion processes. However, the plant-based meat analogues fail to satisfactorily mimic the standard tofu-like structure. Moreover, the plant-based meat analogues have a typical bean-off flavour that makes it difficult to take up flavour from spices. Furthermore, the production of plant-based meat analogue is highly labour-intensive and require vast areas of land, water resources and minerals to grow crops and/or for development of plant-based food sources. Also, the plant-based meat analogues are poor in other nutrients, such as for example iron, vitamins, and so forth.

Recent advances in food technology has extended production of meat analogues using microbes such as yeast, algae, bacteria, and the like. In this regard, techniques such as cell culture followed by extrusion process, 3D-printing techniques, and so forth have been employed to produce microbe-based meat analogues. However, like the plant-based meat analogues, the microbe-based meat analogues lack tofu-like structure and other nutritional characteristics.

Therefore, in light of the foregoing discussion, there exists a need to overcome drawbacks associated with conventional techniques of producing the meat analogue food product that has tofu-like structure.

### SUMMARY

The present disclosure seeks to provide a method of producing a meat analogue food product. The present disclosure also seeks to provide a meat analogue food product obtained from the aforementioned method.

The present disclosure seeks to provide a solution to the existing problem of producing meat analogue food product that mimics firm tofu-like structure. An aim of the present disclosure is to provide a solution that overcomes at least partially the problems encountered in prior art.

In an aspect, an embodiment of the present disclosure provides a method of producing a meat analogue food product, the method comprising:
mixing a microbial biomass protein slurry with a preparation comprising transglutaminase enzyme to obtain a protein mixture;
incubating the protein mixture for a first period of time with mixing at a temperature ranging from 28° C. up to 40° C.;
adding at least one of selected from an aqueous MgCl₂ or an aqueous CaCl₂) to the protein mixture;
incubating the protein mixture for a second period of time at a temperature ranging from 28° C. up to 40° C.;
incubating the protein mixture for a third period of time in a water bath at a temperature ranging from 40° C. up to 60° C.;
heating the protein mixture at a temperature ranging from 60° C. up to 85° C.; and
setting the protein mixture in a closed mold.

In an aspect, an embodiment of the present disclosure provides a meat analogue food product obtained by the aforementioned method having a firm tofu-like structure.

Embodiments of the present disclosure substantially eliminate or at least partially address the aforementioned problems in the prior art, and provides an efficient method of producing the meat analogue food product that imitates firm tofu-like structure and comprises iron and vitamin B12 (cyanocobalamin) which are normally absent in tofu. Beneficially, iron and vitamin B12 are important for oxygen distribution and nervous system.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a flowchart depicting steps of a method of producing a meat analogue food product, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a method of producing a meat analogue food product, the method comprising:
mixing a microbial biomass protein slurry with a preparation comprising transglutaminase enzyme to obtain a protein mixture;
incubating the protein mixture for a first period of time with mixing at a temperature ranging from 28° C. up to 40° C.;
adding at least one of selected from an aqueous MgCl₂ or an aqueous CaCl₂) to the protein mixture;
incubating the protein mixture for a second period of time at a temperature ranging from 28° C. up to 40° C.;
incubating the protein mixture for a third period of time in a water bath at a temperature ranging from 40° C. up to 60° C.;
heating the protein mixture at a temperature ranging from 60° C. up to 85° C.; and
setting the protein mixture in a closed mold.

In another aspect, an embodiment of the present disclosure provides a meat analogue food product obtained by the aforementioned method having a firm tofu-like structure.

The present disclosure provides the aforementioned method of producing the meat analogue food product. The method of the present disclosure comprises utilizing microbial biomass protein slurry derived from microbial biomass, mixed with a transglutaminase enzyme preparation and incubating and setting the resultant protein mixture to produce the desired meat analogue food product. The resultant meat analogue food product imitates firm tofu-like structure, comprises iron and vitamin B12 (cyanocobalamin) (which are normally absent in tofu) that are important for oxygen distribution and nervous system, and does not have bean-off-flavour. Furthermore, the disclosed method is less labour-intensive.

The “firm tofu-like structure” as used herein refers to a tofu structure that does not crumble on picking it up and it is easy to chop. The firm tofu-like structure can be pan-fried, stir-fried, deep-fried, put in a stew, used as a filling or to make spreads. The firm tofu-like structure resembles feta on it's structure.

It will be appreciated that the meat analogue food product obtained from the aforesaid method is a more sustainable, healthier and cruelty-free alternative to standard animal-based meat obtained after sacrificing animals. Moreover, meat analogue food products appeals to a wide demographic of consumers identified as vegetarians or vegans, and some non-vegetarians seeking to reduce their meat consumption. Furthermore, the production of meat analogue food product contributes negligibly to the global warming effect as compared to the production of animal-based meat that releases large amounts of carbon dioxide in the environment.

Throughout the present disclosure, the term “meat analogue food product” as used herein refers to a meat-like product made from animal-free products. Typically, the meat analogue food product is derived from plants or microbes, for example. Generally, the meat analogue food product could be used as a complete food or an ingredient in food, typically, due to certain aesthetic qualities (such as structure, texture, appearance, flavour, for example) or chemical characteristics (such as a protein content, nutrition column, for example) that resemble specific types of animal-based meat. Specifically, the meat analogue food product as disclosed imitates a firm tofu-like structure. Tofu is a typical protein-rich food product prepared from soy. Tofu can be simply made at home by adding transglutaminase enzyme to soy and incubating the resulting mixture. Notably, transglutaminase enzyme binds soy proteins together to form a structure, referred to as the tofu-like structure. Tofu normally does not comprise iron and B12, which are important for oxygen distribution and nervous system. Also, tofu may have a bean-off-flavour, which makes its flavoring more difficult. However, beneficially, the disclosed meat analogue food product is rich in iron and vitamin B12, and does not have bean-off-flavour.

The method comprises mixing a microbial biomass protein slurry with a preparation comprising transglutaminase enzyme to obtain a protein mixture. Throughout the present disclosure, the term “microbial biomass protein slurry” as used herein refers to a nutrient supplement derived from microbial biomass, thus, commonly referred to as single cell proteins (or SCP). It will be appreciated that the microbial biomass protein slurry typically comprises solid phase composed of edible bacterial cells (namely, dry biomass) mixed with a liquid phase (namely, feed medium). Optionally, the dry biomass of the microbial biomass protein slurry may include carbohydrates, fats, minerals, fibre and the like. Notably, bacterial cells could be grown in a bioreactor or through any other conventional process. Typically, the microbial biomass protein slurry provides a concentrated source of proteins with no or negligible carbohydrates, fats or any other compounds. However, the microbial biomass protein slurry comprising proteins and could be fortified with compounds such as vitamins and minerals, such as calcium, iron, and so forth to enhance the overall nutritional column thereof.

The phrase “preparation comprising transglutaminase enzyme” as used herein refers to a composition comprising transglutaminase enzyme. The transglutaminase enzyme is essential for coagulating protein, in protein-containing food products. In this regard, the transglutaminase enzyme catalyses an acyl transfer reaction of a γ-carboxyamide group of a glutamine residue to a ε-amino groups of lysine residue, and cross-linking proteins through covalent bonds between glutamine and lysine amino acids in a peptide chain (of the microbial biomass protein slurry, for example) with subsequent release of ammonia. The transglutaminase enzyme may typically be derived from plants, animals and microorganisms (such as for example bacteria belonging to Streptomyces mobaraensis, Streptomyces cinnamoneum, Bacillus subtilis, and so forth). Moreover, the present disclosure employs microbial transglutaminase enzyme, or plants-derived transglutaminase enzyme. Beneficially, the microbial transglutaminase enzyme is cheaper and easier to produce and purify. Notably, transglutaminase enzyme is commercially available, for example, Ajinornoto Activa® WM transglutaminase preparations. It will be appreciated, the transglutaminase enzyme is characterized by good hydrophilicity, high catalytic activity and strong thermal stability. However, transglutaminase enzyme result in coagulation of proteins if added in a concentration of less than 3% and gelatinization of proteins at concentrations higher than 3%. Beneficially, adding the preparation comprising transglutaminase enables to form a structure, as transglutaminase binds proteins together and without transglutaminase, firm tofu-like structure will not form.

Optionally, the preparation further comprises maltodextrin. Maltodextrin is typically a plant-based food additive. Maltodextrin is mainly used as a thickener and as a preservative. Moreover, the transglutaminase enzyme and the maltodextrin are comprised in the same preparation. The maltodextrin is used to obtain longer preservation time of the meat analogue food product.

Optionally, the preparation comprises sodium caseinate. Sodium caseinate is commonly used as an emulsifier, thickener or stabilizer in food products. Additionally, sodium caseinate improves the properties, such as nutrition, taste and smell, of the food product. However, sodium caseinate is derived from cow's milk and therefore may not be suitable for consumption by lactose-intolerant and vegan consumers.

The method comprises incubating the protein mixture for a first period of time with mixing at a temperature ranging from 28° C. up to 40° C. It will be appreciated that the incubation temperature and period is such that it allows the reaction to proceed to achieve partial cross-linking (but not gelation) of the protein in the microbial biomass protein slurry. Typically, at a laboratory scale, the microbial biomass protein slurry and the preparation comprising transglutaminase enzyme (referred to as “transglutaminase preparation” hereafter) may be mixed in a glass with a magnetic stirrer, for example, at room temperatures. Mixing the microbial biomass protein slurry and the transglutaminase preparation ensures the transglutarnirnnase enzyme to mix properly with the microbial biomass protein slurry and interact with water therein. The temperature may typically range from 28, 30, 32, 34, 36 or 38° C. up to 30, 32, 34, 36, 38 or 40° C. Notably, the transglutaminase enzyme is active within the said temperature range. Moreover, at a laboratory scale, the first period of time of incubating with mixing may be from 20 minutes up to 40 minutes. The first period of time may for example range from 20, 25, 30 or 35 minutes up to 25, 30, 35 or 40 minutes. It will be appreciated that the optimum temperature and the first period of time are indirectly proportional, and the first period of time would be required to be extended if the incubation temperature is set at lower temperatures. It will be appreciated that suitable scaling up could be carried out. Moreover, incubation is done at several steps to enable proper cross-linking and firm tofu-like structure formation.

Optionally, the protein mixture is mixed at speed ranging from 10000 rpm up to 20000 rpm for at least 1 minute in a high-speed mixer, such as an ultra turrax homogenizer. Mixing the protein mixture enables homogenous mixing of the contents therein. Moreover, mixing prevents the maltodextrin from forming lumps in the protein mixture. Therefore, mixing at high-speed for at least one minute enables the meat analogue food product to have a homogenous texture. The mixing speed typically ranges from 10000, 12000, 14000, 16000 or 18000 rpm up to 12000, 14000, 16000, 18000 or 20000 rpm.

Moreover, the method comprises adding at least one of selected from an aqueous MgCl₂ or an aqueous CaCl₂) to the protein mixture. The aqueous MgCl₂ or the aqueous CaCl₂) serve as coagulants. The aqueous MgCl₂ or the aqueous CaCl₂) enhance the activity of the transglutaminase enzyme. It will be appreciated that both the aqueous MgCl₂ and an aqueous CaCl₂) are of food-grade, and provide same results when added to the protein mixture. Moreover, both the aqueous MgCl₂ or an aqueous CaCl₂) can be used together but not at the same time. Notably, calcium ions play an important role in activation and activity of the transglutaminase enzyme. Optionally, other coagulants such as calcium sulphate (CaSO₄) or acids (glucono-δ-lactone (GDL) could be used.

Optionally, the protein mixture is mixed with liquid (such as water), NaCl, spices and preservatives to enhance flavour of the final product. It will be appreciated that the protein mixture, liquid, NaCl and other additives are all used under Good Manufacturing Practices.

Moreover, the protein mixture is incubated for a second period of time. The second period of time of incubation typically ranges from 5 minutes up to 12 minutes, preferably 10 minutes, at room temperature at laboratory scale. The second period of time maybe for example from 5, 6, 7, 8, 9 minutes up to 8, 9, 10, 11, 12 minutes. Moreover, incubating the protein mixture for the second period of time requires no mixing of the protein mixture during the incubation time. It will be appreciated that the incubation time and temperature are different at industrial scale, and therefore may vary according to the amounts of different ingredients of the protein mixture.

Furthermore, the protein mixture is incubated for a third period of time in a water bath at a temperature ranging from 40° C. up to 60° C. It will be appreciated that the incubation for the third period of time in the water bath keeps the transglutaminase enzyme active while avoiding direct contact of the protein mixture with a heater. Similar, to incubating for the second period of time, mixing of the protein mixture is not necessary during incubating for the third period of time. However, at industrial scales, all incubation steps may be performed in a mixing tank with heater to avoid precipitation of the protein mixture. The third period of time may range from 15 minutes up to 40 minutes. The third period of time may be for example from 15, 20, 25, 30 minutes up to 30, 35, 40, 45 minutes. The temperature for the third period of time of incubation typically ranges from 40, 45, 50 or 55° C. up to 45, 50, 55 or 60° C. The transglutaminase enzyme is active up to 60° C. It will be appreciated that slow heating or increase of temperature may be needed to keep the transglutaminase enzyme active. Moreover, beneficially, slow heating partly denatures three-dimensional structure of protein and helps the transglutaminase enzyme to cross-link proteins in the protein mixture.

Furthermore, the protein mixture is heated at a temperature ranging from 60° C. up to 85° C. It will be appreciated that the temperature of the water bath is increased slowly to prevent an early inactivation of the transglutaminase enzyme. Final heating of the protein mixture inactivates the transglutaminase enzyme and imparts a firm tofu-like structure to the protein mixture. The temperature for heating typically ranges from 60, 65, 70, 75 or 80° C. up to 65, 70, 75, 80 or 85° C. Moreover, heating could be done for a longer period of time ranging from 15 minutes up to 45 minutes, for example. Additionally, for a better firm tofu-like structure, more water should be removed from the protein mixture.

Furthermore, the protein mixture is set in a closed mold. The term “closed mold” as used herein refers to a structure with a cavity of a defined cross-section that can hold an amount of fluid (semi-solid), such as the protein mixture, for a pre-defined period of time, and upon pressure application provides a cured product (namely, the meat analogue food product) having a firm structure, such as the firm tofu-like structure, and a defined shape corresponding to the cross-section of the cavity. In this regard, the closed mold comprises a heavy weight to press (namely, exert pressure on) the fluid (semi-solid) to provide it with the desired firm structure. Optionally, the heavy weight is in a direct contact with the protein mixture, or is placed over a plate covering the closed mold. Beneficially, setting the protein mixture in a closed mold result in a high-quality finish product in a time-efficient manner.

Optionally, the protein mixture could be set using an extrusion process. It will be appreciated that the extrusion process impacts mechanically, and increases pressure and temperature resulting in the breaking cell structure of the of the protein mixture.

Optionally, the method further comprises pressing the protein mixture at a temperature ranging from 5° C. up to 7° C. Pressing the protein mixture enable removing excess water from the protein mixture. Optionally, the pressing is performed for a time period ranging from 8 to 12 hours at laboratory scale. The pressing may be carried out from 8, 9, 10 hours up to 9, 10, 11, 12 hours. Optionally, at industrial scale, pressing could be performed using a hydraulic press. The temperature for pressing typically ranges from 5, 5.5, 6 or 6.5° C. up to 5.5, 6, 6.5 or 7° C. Beneficially, low temperatures provide longer shelf-life to the final product, i.e. the meat analogue food product.

Optionally, the pH of the microbial biomass protein slurry is adjusted to be in a range from 5 up to 8. The pH of the microbial biomass protein slurry should be in a range from 5, 5.5, 6, 6.5, 7 or 7.5 up to 5.5, 6, 6.5, 7, 7.5 or 8, preferably, 7.5. In this regard, conventional pH adjustors (acids or bases) could be added to the microbial biomass protein slurry to adjust the pH thereof. It will be appreciated that acidic pH of the microbial biomass protein slurry helps the protein mixture to form firm tofu-like structure. Moreover, acidic pH of the microbial biomass protein slurry enables protein precipitation and, thus, helps formation of firm tofu-like structure.

Optionally, the total weight of the protein mixture before incubating the protein mixture for the second period of time comprises:
from 3% up to 5% of preparation comprising transglutaminase; and
from 1.5% up to 2.5% of at least one of selected from the aqueous MgCl₂ or the aqueous CaCl₂), wherein molarity of the aqueous MgCl₂ or the aqueous CaCl₂) is in a range from 2.5 M to 3.5 M.

In this regard, the protein mixture comprises the transglutaminase enzyme in a range from 3, 3.5, 4 or 4.5% up to 3.5, 4, 4.5 or 5% by weight of the total weight of the protein mixture. Moreover, the protein mixture comprises at least one of selected from the aqueous MgCl₂ or the aqueous CaCl₂) in a range from 1.5, 1.6, 1.7, 1.8, 1.9, 2.0, 2.1, 2.2, 2.3 or 2.4% up to 1.6, 1.7, 1.8, 1.9, 2.0, 2.1, 2.2, 2.3, 2.4 or 2.5% by weight of the total weight of the protein mixture. Furthermore, the molarity of the aqueous MgCl₂ or the aqueous CaCl₂) is in a range from 2.5, 2.6, 2.7, 2.8, 2.9, 3.0, 3.1, 3.2, 3.3 or 3.4 M up to 2.6, 2.7, 2.8, 2.9, 3.0, 3.1, 3.2, 3.3, 3.4 or 3.5 M. In an example, the protein mixture comprises 4% by weight of the transglutaminase enzyme combined with maltodextrin, 2% by weight of 3.15 M aqueous MgCl₂ or 2.97 M aqueous CaCl₂), and 94% by weight of the microbial biomass protein slurry. Optionally, the protein mixture comprises 3 M MgCl₂ in a range from 1.5% up to 2.5%. More optionally, the protein mixture comprises 3 M MgCl₂ in a range from 2% up to 30% of MgCl₂ water solution. Using previously mentioned ranges in the method of the present disclosure enables to obtain extra-firm or even super firm tofu-like structure. Extra-firm tofu-like structure has less water than firm tofu-like structure. The culinary possibilities of firm and extra-firm tofu-like structure are almost the same, but extra-firm tofu-like structure doesn't absorb additives as well. Extra-firm tofu-like structure is easier to pan-fry, stir-fry or deep-fry. Super firm tofu-like structure comprises even less water than extra-firm tofu-like structure and is therefore easiest to fry. It will be appreciated that if the amount of MgCl₂ is higher in the protein mixture, the firm tofu-like structure is more difficult to obtain for the meat analogue food product and it may taste bitter. Similarly, if the amount of MgCl₂ is lower in the protein mixture, the firm tofu-like structure is difficult to obtain for the meat analogue food product and it could taste bitter.

Optionally, the microbial biomass protein slurry comprises from 5% up to 25% of bacterial biomass, and from 75% up to 95% of water. The water is typically from 75, 80, 85 or 90% up to 80, 85, 90 or 95% by weight of the total weight of the microbial biomass protein slurry. The bacterial biomass (namely, Solein) is typically from 5, 10, 15 or 20% up to 10, 15, 20 or 25% by weight of the total weight of the microbial biomass protein slurry. In an example, the microbial biomass protein slurry comprises 89% by weight of water and 5% by weight of protein-rich bacterial biomass.

More optionally, the microbial biomass protein slurry comprises from 20% up to 25% of bacterial biomass. The bacterial biomass is typically from 20, 21, 22, 23 or 24% up to 21, 22, 23, 24 or 25% by weight of the total weight of the microbial biomass protein slurry. It will be appreciated that the amount of bacterial biomass may be altered based on the protein content required in the meat analogue food product. Optionally, the biomass comprises about 65% to 70% of protein, 5% to 8% of fat, 10% to 15% of dietary fibres and 3% to 5% of minerals.

Optionally, the microbial biomass protein slurry comprises a bacterial biomass comprising an isolated bacterial strain deposited as VTT-E-193585 or a derivative thereof. The said isolated bacterial strain or a derivative thereof is typically a Gram-negative bacterium (which do not retain crystal violet stain used in the gram-staining method). It will be appreciated that the said isolated bacterial strain or a derivative thereof is genetically stable and can be grown in a broad range of process conditions, ranging from optimal to stressful conditions, over time. The term “genetically stable” as used herein, refers to a characteristic of a species or a strain/isolate to resist changes and maintain its genotype over multiple generations or cell divisions, ideally hundreds to thousands. Optionally, the said isolated bacterial strain or a derivative thereof utilize hydrogen gas as energy source and carbon dioxide as carbon source. Beneficially, the said strain or the derivative thereof comprises iron and vitamin B12. Moreover, the final product resulting from the said strain or the derivative thereof does not have a bean-off-flavor and is therefore easier to flavor. Possibly, the final product also has umami (namely, savory or “meat-like”) flavor.

Optionally, the microbial biomass protein slurry is produced via upstream and downstream processes, the downstream process comprising following steps:
cultivating bacterial cells by gas fermentation to obtain a biomass;
incubating the biomass with a heat treatment at a temperature ranging from 55° C. up to 75° C. for 15 minutes up to 40 minutes.
separating a liquid phase and a solid phase of the biomass and concentrating the biomass by removing the liquid phase; and
homogenizing the bacterial cells of the biomass to obtain a microbial biomass protein slurry.

In this regard, optionally, the upstream process comprises creating an optimum environment for the bacterial cells to grow and make the desired intracellular protein(s). Optionally, the upstream process comprises genetically engineering the bacterial cells to produce high yield of the desired protein and/or other nutritional components, such as antioxidants, iron, vitamins, and so forth. It will be appreciated that one or more batches of bacterial cells that make the desired intracellular protein(s) are selected as a starting material or an inoculum for further growth thereof. The term “downstream processing” as used herein refers to the process that follows the selection of bacterial cells producing high yield of protein. Typically, the downstream processing are unit operations that facilitate production of the final product in a manner useful for the consumers (humans or animals) thereof. In this regard, the downstream processing comprises subjecting the bacterial cells to physiological, chemical and mechanical conditions, to provide a final product that is suitable and safe for use by the consumers.

The downstream process initiates with cultivating bacterial cells. The term “biomass” as used herein refers to a measure of amount of living component (namely, bacteria) in a sample. Notably, the biomass comprises a solid phase (i.e. bacterial cells) and a liquid phase (growth medium). Moreover, the bacterial cells are cultivated (namely, cultured) in a media suspension (comprising a carbon source, a nitrogen source, an energy source, minerals and other specific nutrients) within vessels called bioreactors under controlled conditions (such as temperature, humidity, pH, and any of an aerobic, anaerobic or facultative condition, for example). It will be appreciated that the process of using of gases like hydrogen, carvon dioxide and carbon monoxide as energy and carbon sources by the bacterial cells for growth is referred to as the “gas fermentation”. Optionally, a feed for cultivating by gas fermentation comprises at least one of selected from CO₂, CH₄, H₂, O₂, NH₃, at least one mineral. It will be appreciated that addition of minerals, such as minerals containing ammonium, phosphate, potassium, sodium, vanadium, iron, sulphate, magnesium, calcium, molybdenum, manganese, boron, zinc, cobalt, selenium, iodine, copper and/or nickel enhance growth of bacterial cells. Moreover, addition of NH₃ provides a nitrogen source for the bacterial cells.

Optionally, the biomass could be produced in continuous or batch cultivation of the bacterial cells. It will be appreciated that microbes have shorter reproduction time and, thus, can be grown rapidly to produce high cell density biomass. Beneficially, the high cell density of the biomass is sufficient for production of protein for consumption by humans for example. Additionally, beneficially, large-scale production of biomass and a harvesting thereof is easier and cost efficient as compared to harvesting protein from a single bacterial cell due to the need for highly efficient micro-scale laboratory equipment.

Moreover, the cultivated biomass having a high cell density is harvested and further subjected to processing steps, such as incubation, separation, homogenization and drying for example, to obtain the desired final product.

The biomass is incubated with a heat treatment at a temperature ranging from 55° C. up to 75° C. for 15 minutes up to 40 minutes. Notably, incubation and heat treatment facilitates certain chemical and structural changes in the bacterial cells. Specifically, incubating facilitates disrupting the cell wall to release lipopolysaccharides, some of which are endotoxins, that could be harmful to the humans if they translocate from the gut into the bloodstream. The incubation may for example be carried out at temperatures from 55, 60, 65 or 70° C. up to 60, 65, 70 or 75° C. for the incubation time ranging from 15, 20, 25, 30 or 35 minutes up to 20, 25, 30, 35 or 40 minutes, preferably, 60, 65 or 70° C. up to 65, 70 or 75° C. for 20, 25 or 30 minutes up to 25, 30 or 35 minutes. Beneficially, cell wall degradation as a result of incubation of biomass results in a final product, i.e. the meat analogue food product, with at least 10-1000 times lower endotoxin response. Additionally, incubation at the aforesaid temperature range prevents growth of unwanted microbes and result in a pure culture of only the desired bacteria.

Optionally, separating is carried out with a separation method selected from at least one of a centrifugation, a filtration. Centrifugation is typically a technique for the separation of particles according to their size, shape, density, viscosity or speed of rotor employed for separation. In this regard, the solution is placed in a centrifuge tube that is then placed in rotor and spun at a definite speed. Optionally, centrifugation is performed with a centrifugal force ranging between 10000×g and 20000×g. The centrifugation separates about 90-95% of liquid phase from the solid phase. It will be appreciated that centrifugation is the most efficient and easiest way to separate the liquid and solid phases. The filtration technique typically separates the liquid and solid phases through a semi-permeable membrane that allows the liquid phase to pass therethrough while retaining the solid phase over the said semi-permeable membrane. The filtration provides the most energy-efficient way to separate the liquid phase from the solid phase. It will be appreciated that along with the liquid phase, hydrolysed components of the cell wall structures including the lipopolysachharides are removed from the concentrated biomass, thus, leaving the concentrated biomass with reduced endotoxins therein.

Notably, homogenizing at least partially degrades cell walls of the bacterial cells. The term “homogenizing” as used herein refers to a means of physical disruption of the bacterial cell walls. It will be appreciated that incubating the bacterial cells partially disrupts their cell walls, and homogenizing the biomass further disrupts the cell walls. Typically, homogenizing exploits fluid flow, particle-particle interaction, and pressure drop to facilitate cell disruption. Beneficially, homogenizing results in partial lysis of bacterial cells and increasing soluble protein content of the biomass thereby improving functional properties of the biomass as a food product. Typically, used homogenizing devices include mortar and pestle, blenders, bead mills, sonicators, rotor-stator, and the like. Additionally, homogenizing the biomass further removes lipopolysachharides remaining in the concentrated biomass, thereby further reducing from the homogenized biomass. Optionally, homogenizing could be carried out using a high-pressure homogenization (or microfluidization) or a milling technique. The term “high-pressure homogenization” as used herein refers to a physical or mechanical process of forcing a stream of sample, such as the concentrated biomass, through a high-pressure homogenizing device to homogenize the sample and/or reduce the particle size of any components within the sample. Typically, the high-pressure homogenizing device subjects the sample to a plurality of forces, such as high pressure or any combination of shear forces for example.

Optionally, the homogenizing is carried out at a pressure ranging from 800 bars up to 2000 bars for at least one run. The homogenization pressure may, for example, be from 800, 1000, 1200, 1400, 1600 or 1800 bars up to 1000, 1200, 1400, 1600, 1800 or 2000 bars. The term “at least one run” as used herein refers to the number of cycles or passes (such as once, twice or thrice) the concentrated biomass is subjected to increase cell disruption efficiency. More optionally, the homogenizing is carried out at a pressure ranging from 700 bars up to 1000 bars. The homogenization pressure may, for example, be from 700, 750, 800, 850, 900 or 950 bars up to 750, 800, 850, 900, 950 or 1000 bars, preferably, 900 bars. Beneficially, the said range of homogenization pressure provides best results with increased soluble protein content and decreased endotoxin levels in the homogenized biomass.

Beneficially, the meat analogue food product obtained using the disclosed method has firm tofu-like structure, and comprises iron and B12, which are important for oxygen distribution and nervous system but are missing normally missing in the plant-based tofu. Additionally, beneficially, the meat analogue food product lacks the bean-off-flavour typical of plant-based tofu, and therefore is easier to flavour using flavouring agents or spices. Also, the meat analogue food product has a yellow colour, which is caused by beta-carotene comprised in the biomass.

### DETAILED DESCRIPTION OF THE DRAWINGS

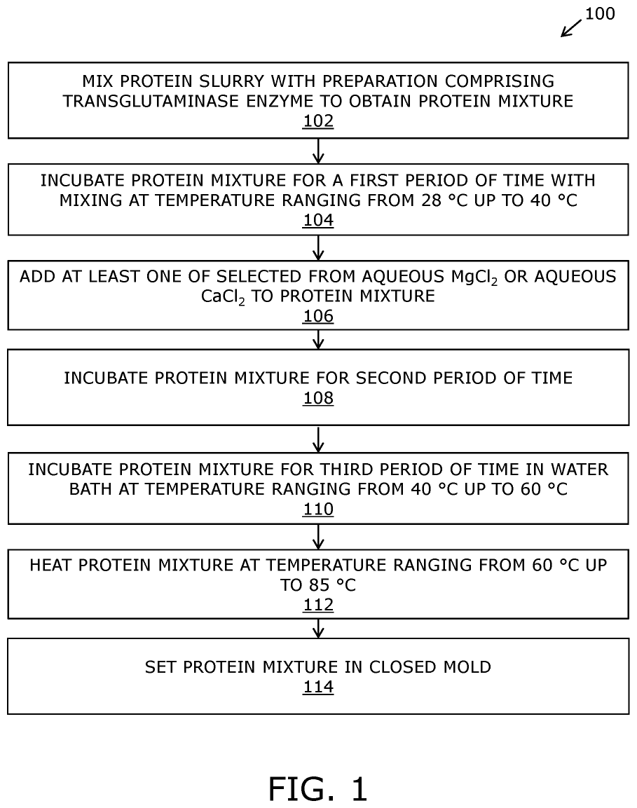

Referring to FIG. 1, there is shown a flowchart 100 illustrating steps of a method of producing a meat analogue food product, in accordance with an embodiment of the present disclosure. At step 102, a microbial biomass protein slurry is mixed with a preparation comprising transglutaminase enzyme to obtain a protein mixture. At step 104, the protein mixture is incubated for a first period of time with mixing at a temperature ranging from 28° C. up to 40° C. At step 106, at least one of selected from an aqueous MgCl₂ or an aqueous CaCl₂) is added to the protein mixture. At step 108, the protein mixture is incubated for a second period of time. At step 110, the protein mixture is incubated for a third period of time in a water bath at a temperature ranging from 40° C. up to 60° C. At step 112, the protein mixture is heated at a temperature ranging from 60° C. up to 85° C. At step 114, the protein mixture is set in a closed mold.

The steps 102, 104, 106, 108, 110, 112 and 114 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method of producing a meat analogue food product, the method comprising:
mixing a microbial biomass protein slurry with a preparation comprising transglutaminase enzyme to obtain a protein mixture;
incubating the protein mixture for a first period of time with mixing at a temperature ranging from 28° C. up to 40° C.;
adding at least one of selected from an aqueous MgCl₂ or an aqueous CaCl₂ to the protein mixture;
incubating the protein mixture for a second period of time at a temperature ranging from 28° C. up to 40° C.;
incubating the protein mixture for a third period of time in a water bath at a temperature ranging from 40° C. up to 60° C.;
heating the protein mixture at a temperature ranging from 60° C. up to 85° C.; and
setting the protein mixture in a closed mold.

2. The method according to claim 1, wherein the preparation further comprises maltodextrin.

3. The method according to claim 1, further comprising pressing the protein mixture at a temperature ranging from 5° C. up to 7° C.

4. The method according to claim 1, wherein the pH of the microbial biomass protein slurry is adjusted to be in a range from 5 up to 8.

5. The method according to claim 1, wherein the total weight of the protein mixture before incubating the protein mixture for the second time comprises:
from 3% up to 5% of preparation comprising transglutaminase; and
from 1.5% up to 2.5% of at least one of selected from the aqueous MgCl₂ or the aqueous CaCl₂, wherein molarity of the aqueous MgCl₂ or the aqueous CaCl₂ is in a range from 2.5 M to 3.5 M.

6. The method according to claim 1, wherein the protein mixture is mixed at speed ranging from 10000 rpm up to 20000 rpm for at least 1 minute in a high-speed mixer.

7. The method according to claim 1, wherein the microbial biomass protein slurry comprises:
from 5% up to 25% of bacterial biomass, and
from 75% up to 95% of water.

8. The method according to claim 7, wherein the microbial biomass protein slurry comprises from 20% up to 25% of bacterial biomass.

9. The method according to claim 1, wherein the microbial biomass protein slurry comprises a bacterial biomass comprising an isolated bacterial strain deposited as VTT-E-193585 or a derivative thereof.

10. The method according to claim 1, wherein the microbial biomass protein slurry is produced via upstream and downstream processes, the downstream process comprising following steps:
cultivating bacterial cells by gas fermentation to obtain a biomass;
incubating the biomass with a heat treatment at a temperature ranging from 55° C. up to 75° C. for 15 minutes up to 40 minutes.
separating a liquid phase and a solid phase of the biomass and concentrating the biomass by removing the liquid phase; and
homogenizing the bacterial cells of the biomass to obtain a microbial biomass protein slurry.

11. The method according to claim 10, wherein the homogenizing is carried out at a pressure ranging from 800 bars up to 2000 bars for at least one run.

12. The method according to claim 10, wherein the homogenizing is carried out at a pressure ranging from 700 bars up to 1000 bars.

13. The method according to claim 10, wherein a feed for cultivating by gas fermentation comprises at least one of selected from CO₂, CH₄, H₂, O₂, NH₃, at least one mineral.

14. A meat analogue food product obtained by the method according claim 1, wherein the meat analogue food product has a firm tofu-like structure.
